(19) United States
(12) Patent Application Publication
(10) Pub. No.: US 2012/0268575 A1
(43) Pub. Date: Oct. 25, 2012

(54) ELECTRONIC APPARATUS AND VIDEO DISPLAY METHOD

(75) Inventor: Koichi Senuma, Oume-shi (JP)

(73) Assignee: KABUSHIKI KAISHA TOSHIBA, Tokyo (JP)

(21) Appl. No.: 13/360,534

(22) Filed: Jan. 27, 2012

(30) Foreign Application Priority Data
Apr. 19, 2011 (JP) 2011-092859

(51) Int. Cl. H04N 13/04

(52) U.S. Cl. 348/51; 348/E13.075

(57) ABSTRACT

According to one exemplary embodiment, an electronic apparatus includes: a controller which determines whether to display 2D video or 3D video as video corresponding to a video signal according to a size of a display window in which the video corresponding to the video signal is to be displayed; an image processor which generates 2D video data or 3D video data based on the video signal according to a determination result of the controller; and a display module which displays, in the display window, any one of 2D video corresponding to the 2D video data and 3D video corresponding to the 3D video data.

### CROSS REFERENCE TO RELATED APPLICATION(S)

The application is based upon and claims the benefit of priority from Japanese Patent Application No. 2011-092859 filed on Apr. 19, 2011; the entire content of which are incorporated herein by reference.

### FIELD

Exemplary embodiments described herein relate generally to an electronic apparatus and a video display method.

### BACKGROUND

In recent years, personal computers capable of 3D video display have been spreading. In personal computers of this type, plural parallax images corresponding to different viewing points are displayed on a display unit and the user can recognize 3D video by looking at different parallax images through his or her right eye and left eye.

It is a general procedure that video of a reproduced video signal is displayed in a display window which is displayed in a display unit. In many cases, the size of the display window can be changed arbitrarily by the user. To attain 3D display, it is necessary to display plural parallax images in the display window. As the size of the display window decreases, the amount of information displayed therein is reduced and the image quality is lowered (e.g., outlines in an image become less discernible).

### BRIEF DESCRIPTION OF THE DRAWINGS

Exemplary embodiments of the present invention will be described in detail based on the following figures, wherein:

FIG. 1 is a perspective view of an electronic apparatus (personal computer) 100 according to an embodiment;

FIG. 2 is a block diagram outlining the system configuration of the personal computer 100;

FIG. 3 is a block diagram outlining the configuration of a video display system of the personal computer 100;

FIG. 4 is a flowchart of an example process that is executed by the video display system;

FIG. 5 conceptually shows 2D video displayed in the display window 23; and

FIG. 6 conceptually shows 3D video displayed in the display window 23.

### DETAILED DESCRIPTION OF THE EXEMPLARY EMBODIMENTS

In general, according to one exemplary embodiment, an electronic apparatus includes: a controller which determines whether to display 2D video or 3D video as video corresponding to a video signal according to a size of a display window in which the video corresponding to the video signal is to be displayed; an image processor which generates 2D video data or 3D video data based on the video signal according to a determination result of the controller; and a display module which displays, in the display window, any one of 2D video corresponding to the 2D video data and 3D video corresponding to the 3D video data.

An embodiment of will be hereinafter described in detail with reference to the drawings.

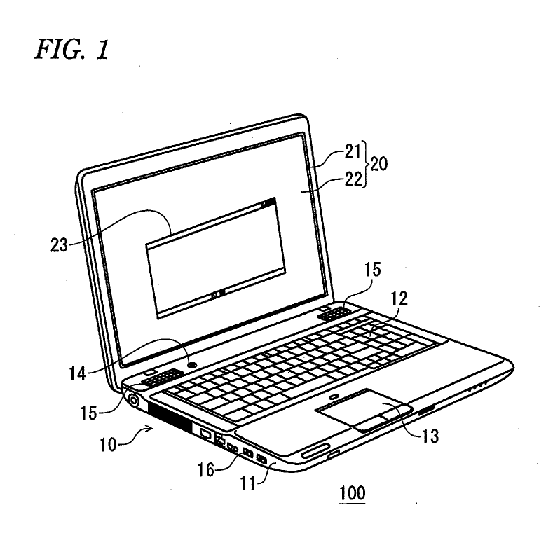

FIG. 1 is a perspective view of an electronic apparatus 100, which is a personal computer. The personal computer 100 is provided with a main unit 10 and a display unit 20.

The main unit 10 has a thin, box-shaped case 11. The top surface of the case 11 is provided with a keyboard 12, a touch pad 13, a power button 14, speakers 15, etc. A central processing unit (CPU), a main memory, an HDD, etc. (described later) are provided inside the case 11.

The keyboard 12 is an input device for generating a signal indicating the content of an operation such as character input or icon selection. The touch pad 13 is a pointing device for generating a signal indicating the content of an operation such as a transition between pictures, cursor movement, or icon selection. The power button 14 is a switch for powering on or off the personal computer 100. The top surface of the case 11 may also be provided with various indicators indicating, for example, whether the personal computer 100 is powered on or off and whether or not a battery is being charged as well as buttons for activating prescribed functions.

The display unit 20 includes a display panel 21 and an output direction controller 22, and is connected to the main unit 10 rotatably by hinges (not shown). The display panel 21 can display 2D video in a display window (described later) and can also display 3D video by displaying plural parallax images corresponding to different viewing points. One important feature of the embodiment is that a controller 30 (described later) can automatically switch between 2D video display and 3D video display.

To display 3D video, the output direction controller 22 controls the output direction of video that is displayed on the display panel 21 so that one parallax image reaches the right eye of the user and the other parallax image reaches the left eye of the user. The output direction may be either controlled to predetermined directions or controlled by tracking the right eye and the left eye of the user using a camera (not shown) provided on the personal computer 100. The output direction controller 22 is, for example, a liquid crystal filter. The output direction controller 22 can control the output direction by varying the orientation of a liquid crystal material.

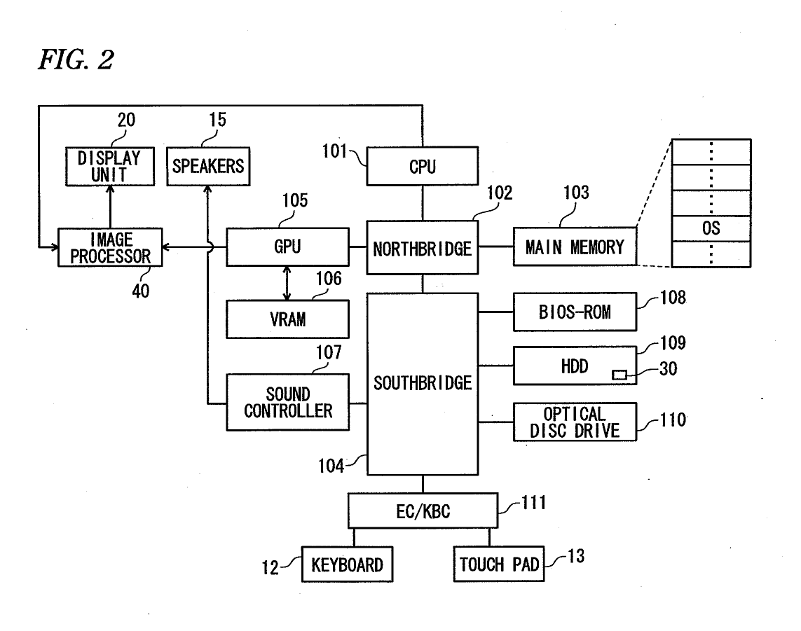

FIG. 2 is a block diagram outlining the system configuration of the personal computer 100. The personal computer 100 is provided with a CPU 101, a northbridge 102, a main memory 103, a southbridge 104, a graphic processing unit (GPU) 105, an image processor 40, the display unit 20, a VRAM (video memory) 106, a sound controller 107, the speakers 15, a basic input/output system-read only memory (BIOS-ROM) 108, an HDD 109, an optical disc drive 110, and an embedded controller/keyboard controller (EC/KBC) 111.

The CPU 101 is a processor which controls operations of the personal computer 100. The CPU 101 runs an operating system (OS) and various application programs that are loaded into the main memory 103 from the HDD 109. For example, in the embodiment, the CPU 101 controls the image processor 40 by running application programs that are stored in the HDD 109 as corresponding to the controller 30. The CPU 101 also runs a system BIOS that is loaded into the main memory 103 from the BIOS-ROM 108. The system BIOS is programs for hardware control.

The northbridge 102 is a bridge device which connects the CPU 101 to the southbridge 104. The northbridge 102 incorporates a memory controller for controlling the main memory 103. The northbridge 102 performs a communication with the GPU 105 via a serial bus. The main memory 103 is a working memory in which the OS and the various application programs stored in the HDD 109 and the system BIOS stored in the BIOS-ROM 108 are to be developed. The southbridge 104 controls the BIOS-ROM 108, the HDD 109 and the optical disc drive 110. The southbridge 104 also controls a communication with the sound controller 107.

The GPU 105 outputs a video signal stored in the VRAM 106 to the display unit 20 via the image processor 40 (described later). The sound controller 107 sends replaying-subject audio data to the speakers 15 so that the data are output from the speakers 15. The EC/KBC 111 is a one-chip microcomputer in which an embedded controller for power management and a keyboard controller for controlling the keyboard 12, the touch pad 13, etc. are integrated together. The EC/KBC 113 controls power-on/off of the personal computer 100 in response to a user operation of the power button 14.

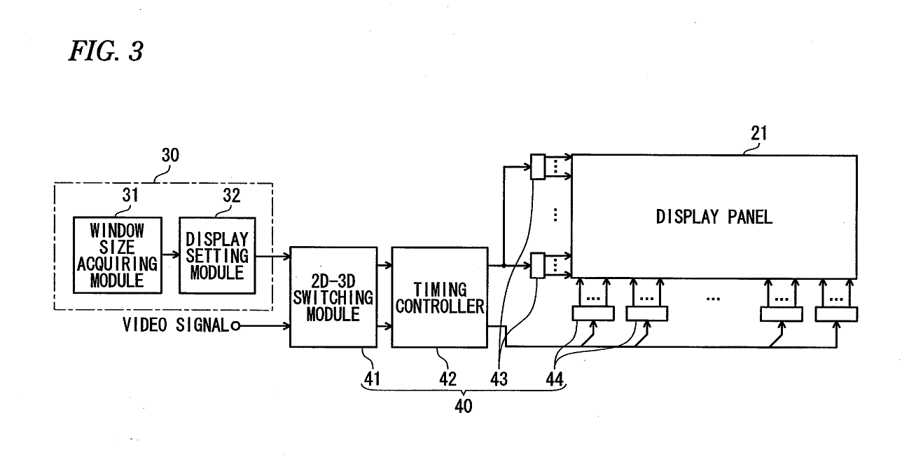

FIG. 3 is a block diagram outlining the configuration of a video display system of the personal computer 100 according to the embodiment. The video display system includes the controller 30, the image processor 40, and the display panel 21.

The controller 30 includes a window size acquiring module 31 and a display setting module 32. The window size acquiring module 31 acquires a window size of a display window 23 which is displayed on the display panel 21. The display setting module 32 determines whether to perform 2D display or 3D display according to the acquired window size, and supplies a determination result to the image processor 40. The controller 30 is stored in the HDD 109 as application programs and run by the CPU 101.

The display panel 21 is a liquid crystal panel whose diagonal length is 15.6 inches, for example, and has a structure that a liquid crystal is inserted between a pair of glass substrates that are opposed to each other. The display panel 21 has plural (e.g., 768) scanning lines, plural (e.g., 1,366×3) signal lines, and liquid crystal pixels formed at intersecting positions of the scanning lines and the signal lines. A backlight (not shown) for illuminating the display panel 21 with light is disposed behind the display panel 21.

When a video signal that is stored in the HDD 109 or an optical disc or the like inserted in the optical disc drive 110 is reproduced, the display panel 21 displays video corresponding to the video signal in the display window 23. As shown in FIG. 1, the display window 23 is, for example, a display area in which to display video. The display window 23 may be provided with shortcut buttons for hiding the display window 23 temporarily (minimization), displaying the display window 23 over the entire display panel 21 (maximization), and closing the display window 23, respectively, as well as icons for controlling reproduce, pause, etc. of a video signal. The size of the display window 23 can be varied arbitrarily by the user by dragging an edge of the display window 23 using the touch pad 13 or specifying the numbers of pixels in the vertical direction and the horizontal direction using the keyboard 12.

The image processor 40 shown in FIG. 3 supplies a video signal to the display panel 21 as 2D video data or 3D video data according to a determination result of the controller 30. More specifically, the image processor 40 includes a 2D-3D switching module 41, a timing controller 42, gate drivers 43, and source drivers 44. For example, the image processor 40 is composed of plural integrated circuits (ICs).

The 2D-3D switching module 41 converts a video signal that is input from the GPU 105 into 2D video data or 3D video data according to a determination result of the controller 30, and supplies the latter to the timing controller 42. 2D video data and 3D video data are video data to be used for displaying 2D video and 3D video, respectively, corresponding to a video signal that is input from the GPU 105, and are analog signals having such formats as to be displayable by the display panel 21.

3D video data includes data of plural parallax images, that is, at least two (right-eye and left-eye) parallax images. In the case of a left-eye parallax image, pixels that should look as if to exist on the viewer's side look deviated to the right more than pixels that should look as if to exist on the deep side. Therefore, the 2D-3D switching module 41 generates a left-eye parallax image by shifting, rightward, pixels that should look as if to exist on the viewer's side using depth information and interpolating, as appropriate, pixels at the original positions using nearby pixels. The 2D-3D switching module 41 generates a right-eye parallax image in a similar manner. The depth information is information indicating to what extent each pixel should look as if to exist on the viewer's side or the deep side of the display panel 21. The depth information may be either contained in a video signal or generated based on features of a video signal.

The timing controller 42 supplies 2D video data or 3D video data to the source drivers 44 and controls the operation timing of the gate drivers 43 and the source driver 44. The gate drivers 43 select the scanning lines in order one at a time. The source drivers 44 supply video data to the signal lines. The video data are supplied to the liquid crystal pixels that are connected to a scanning line selected by the gate drivers 43, whereby the orientations of the portions of the liquid crystal material in those liquid crystal pixels are varied according to the video data. Light that is emitted from the backlight and shines on those portions of the liquid crystal material partially passes through those portions of the liquid crystal material depending on their orientations, whereby video corresponding to the video data is displayed on the display panel 21.

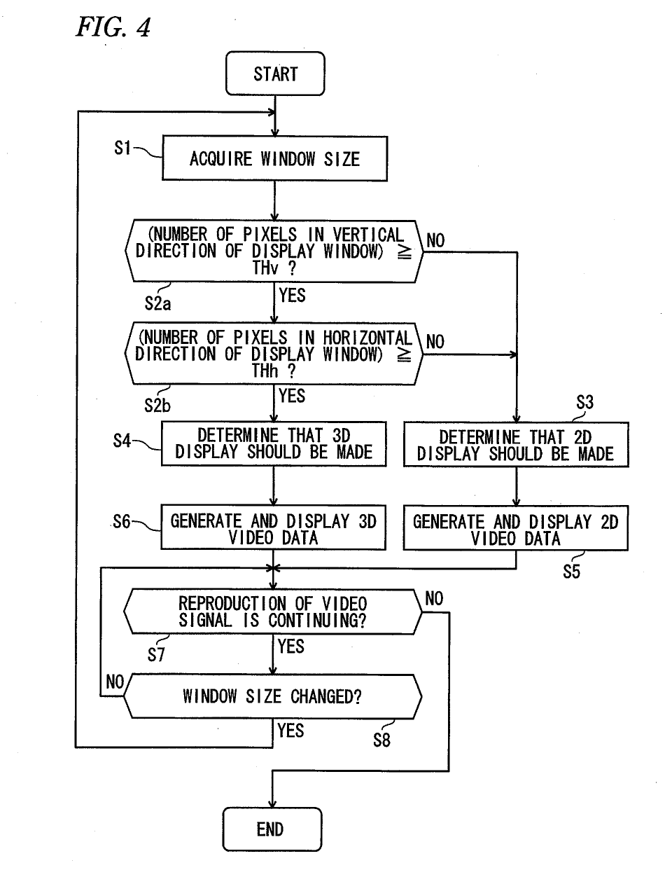

FIG. 4 is a flowchart of an example process that is executed by the video display system. When the CPU 101 reproduces a video signal, a display window 23 in which to display video corresponding to the video signal is displayed on the display panel 21. At step S1, the window size acquiring module 31 acquires, as a window size, the number of pixels in the horizontal direction and the number of pixels in the vertical direction of the display window 23.

Next, the display setting module 32 determines according to the window size whether to display 2D video or 3D video. More specifically, if the number of pixels in the vertical direction is smaller than a threshold value THv (first threshold value) (No at step S2a) or the number of pixels in the horizontal direction is smaller than a threshold value THh (second threshold value) (No at step S2b), the display setting module 32 determines at step S3 that 2D display should be made because the size of the display window 23 is small.

On the other hand, if the number of pixels in the vertical direction is larger than equal to the threshold value THv (Yes at step S2a) and the number of pixels in the horizontal direction is larger than equal to the threshold value THh (Yes at step S2b), the display setting module 32 determines at step S4 that 3D display should be made because the size of the display window 23 is large.

The display setting module 32 may either use predetermined, fixed values as the threshold values THv and THh or set the threshold values THv and THh according to the resolution of a video signal. For example, when a video signal having a resolution of 720×480 pixels (standard image quality) that is stored in a digital versatile disc (DVD) is reproduced, the display setting module 32 sets the threshold values THv and THh at 360 and 540, respectively. When a video signal having a resolution of 1,920×1,080 pixels (Hi-Vision image quality) that is stored in an high-definition DVD (HD DVD) or a Blu-ray disc (BD) is reproduced, the display setting module 32 sets the threshold values THv and THh at 576 and 1,024, respectively, which are larger than those for the standard image quality resolution. This is because the vision-related quality of 3D video generated through conversion lowers as the reduction ratio increases. When a reproduced video signal has the Hi-Vision image quality resolution which is higher than the standard image quality resolution, the threshold values THv and THh are set larger than the values for the standard image quality resolution.

The display setting module 32 may set the threshold values THv and THh according to the diagonal length of the display panel 21. More specifically, the threshold values THv and THh may be set larger as the display panel 21 becomes larger. This is because the vision-related quality of 3D video generated through conversion lowers as the ratio of the display window 23 to the size of the display panel 21 decreases.

The display setting module 32 may set the threshold values THv and THh larger as the distance between the display panel 21 and the user who is watching video becomes longer. This is because it becomes more difficult to recognize details of video correctly as the distance from the display panel 21 becomes longer. The distance may be either acquired automatically by mounting a camera (not shown) on the personal computer 100 or set by the user.

Furthermore, the threshold values THv and THh may be set according to the resolution of the display panel 21, the angle at which the user views the display panel 21, or a combination thereof.

If it is determined that 2D display should be made at step S3, the 2D-3D switching module 41 generates 2D video data from the video signal and supplies the 2D video data to the timing controller 42 and 2D video corresponding to the 2D video data is displayed on the display panel 21 at step S5.

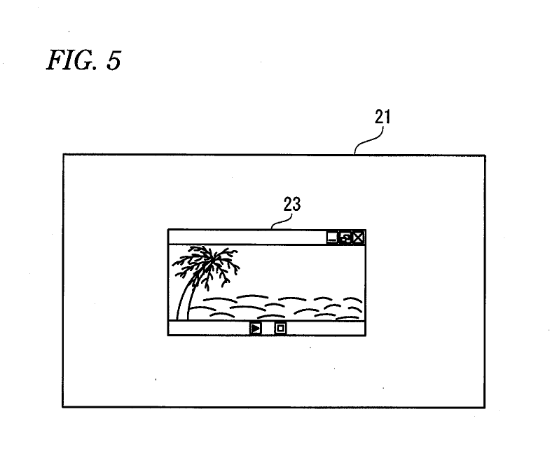

FIG. 5 conceptually shows 2D video displayed in the display window 23. As shown in FIG. 5, 2D video, rather than 3D video, is displayed when the display window 23 is small. Therefore, high-quality video which is free of trouble that outlines are less discernible can be displayed.

On the other hand, if it is determined at step S4 that 3D display should be made, at step S6 the 2D-3D switching module 41 generates 3D video data from the video signal and supplies the 3D video data to the timing controller 42 and 3D video corresponding to the 3D video data is displayed on the display panel 21.

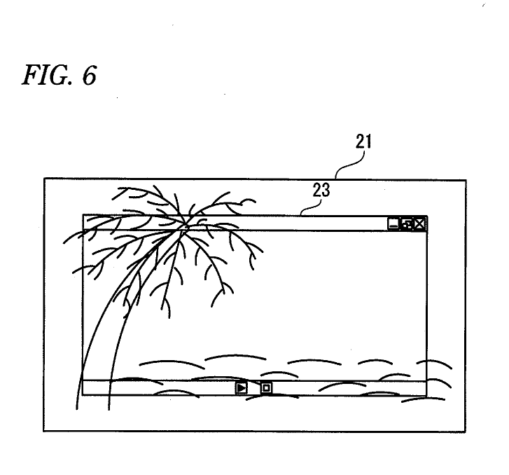

FIG. 6 conceptually shows 3D video displayed in the display window 23. As shown in FIG. 6, 3D video is displayed when the display window 23 is large. Therefore, 3D video can be displayed without image quality degradation.

As long as the video signal continues to be reproduced (Yes at step S7), the process returns to step S1 every time the size of the display window 23 is changed (Yes at step S8).

As described above, in the embodiment, 2D video is displayed when the size of the display window 23 is small and 3D video is displayed when the size of the display window 23 is large. This makes it possible to display high-quality video irrespective of the window size.

In the process of FIG. 4, the display setting module 32 determines whether to make 2D display or 3D display based on the number of pixels in the vertical direction (step S2a) and the number of pixels in the horizontal direction (step S2b) of the display window 23. Alternatively, the display setting module 32 may make such a determination in a simplified manner by acquiring only one of those numbers. Furthermore, the display setting module 32 may make such a determination based on the number of pixels that constitute the diagonal line of the display window 23 or the number of pixels existing in the display window 23. A length may be used instead of the number of pixels.

At least part of the video display system according to the embodiment may be implemented by either hardware or software. Where at least part of the video display system according to the embodiment is implemented by software, programs for implementing functions of the at least part of the video display system may be stored in a recording medium such as a flexible disk or a CD-ROM and have the personal computer 100 read and execute those programs. The recording medium is not limited to detachable ones such as a magnetic disk and an optical disc and may be a fixed one such as a hard disk drive or a memory.

Programs for implementing functions of the at least part of the video display system may be delivered over a communication line (including delivery by a wireless communication). Such programs may be delivered over a wired line such as the Internet or wireless line or in the form of information stored in a recording medium in a state that they are encrypted, modulated, or compressed.

While certain exemplary embodiment has been described, the exemplary embodiment has been presented by way of example only, and is not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus comprising:
a controller configured to determine whether to display 2D video or 3D video corresponding to a video signal according to a size of a display window in which the video corresponding to the video signal is to be displayed;
an image processor configured to generate 2D video data or 3D video data based on the video signal according to the determination of the controller; and
a display module configured to display, in the display window, any one of 2D video corresponding to the 2D video data and 3D video corresponding to the 3D video data.

2. The apparatus of claim 1, wherein the controller is further configured to determine whether to display 2D video or 3D video according to at least one of the number of pixels in a vertical direction and the number of pixels in a horizontal direction of the display window.

3. The apparatus of claim 2, wherein the controller is further configured to determine that 3D video should be displayed if the number of pixels in the vertical direction is larger than or equal to a first threshold value and the number of pixels in the horizontal direction is larger than or equal to a second threshold value.

4. The apparatus of claim 3, wherein the controller is further configured to determine that 2D video should be displayed if the number of pixels in the vertical direction is smaller than the first threshold value or the number of pixels in the horizontal direction is smaller than the second threshold value.

5. The apparatus of claim 3, wherein the first threshold value and the second threshold value are configured to be set larger when the video signal has a higher resolution, the display panel is larger, or a distance between the display panel and a user watching the video is longer.

6. The apparatus of claim 1, wherein the controller is further configured to determine whether to display 2D video or 3D video according to at least one of a diagonal length of the display window and the number of pixels in the display window.

7. The apparatus of claim 1, wherein the controller is further configured to determine whether to display 2D video or 3D video according to a new window size when the size of the display window is changed.

8. The apparatus of claim 1, wherein the image processor is further configured to generate 3D video data comprising a plurality of parallax images corresponding to different viewing points.

9. A video display method comprising:
determining whether to display 2D video or 3D video corresponding to a video signal according to a size of a display window in which the video corresponding to the video signal is to be displayed;
generating 2D video data or 3D video data based on the video signal according to a result of the determining step; and
displaying, in the display window, any one of 2D video corresponding to the generated 2D video data and 3D video corresponding to the generated 3D video data.

10. The method of claim 9, wherein the determining step further determines whether to display 2D video or 3D video according to at least one of the number of pixels in a vertical direction and the number of pixels in a horizontal direction of the display window.

11. The method of claim 10, wherein the determining step further determines that 3D video should be displayed if the number of pixels in the vertical direction is larger than or equal to a first threshold value and the number of pixels in the horizontal direction is larger than or equal to a second threshold value.

12. The method of claim 11, wherein the determining step further determines that 2D video should be displayed if the number of pixels in the vertical direction is smaller than the first threshold value or the number of pixels in the horizontal direction is smaller than the second threshold value.

13. The method of claim 11, wherein the first threshold value and the second threshold value are set larger when the video signal has a higher resolution, a display panel for displaying the video is larger, or a distance between the display panel and a user watching the video is longer.

14. The method of claim 9, wherein the determining step further determines whether to display 2D video or 3D video according to at least one of a diagonal length of the display window and the number of pixels in the display window.

15. The method of claim 9, wherein the determining step further determines whether to display 2D video or 3D video according to a new window size when the size of the display window is changed.

16. The method of claim 9, wherein the generating step further generates 3D video data comprising a plurality of parallax images corresponding to different viewing points.
